(19) United States
(12) Patent Application Publication
(10) Pub. No.: US 2013/0107035 A1
(43) Pub. Date: May 2, 2013

(54) METHOD AND SYSTEM FOR IN-SITU VISUAL INSPECTION OF A VALVE

(71) Applicants: Alex Afonso, St. John's Newfoundland (CA); Stephen Chafe, St. John's Newfoundland (CA)

(72) Inventors: Alex Afonso, St. John's Newfoundland (CA); Stephen Chafe, St. John's Newfoundland (CA)

(73) Assignee: SSV Inspections Inc., St John's Newfoundland, CA (US)

(21) Appl. No.: 13/809,176

(22) PCT Filed: Jun. 16, 2011
(86) PCT No.: PCT/CA2011/000702

§ 371 Date: Jan. 9, 2013

(51) Int. Cl. H04N 7/18

(52) U.S. Cl. CPC H04N 7/18
USPC 348/125

(57) ABSTRACT

A method for visually inspecting a valve is provided. The valve controls of a fluid from a first fluid conduit to a second fluid conduit. A tethered imaging device is disposed in the second fluid conduit. The tether extends from inside the second fluid conduit to outside the second fluid conduit. An image capturing end portion of the imaging device is moved in proximity to the valve. A fluid seal for fluid sealing a passage of the tether from inside the second fluid conduit to outside the second fluid conduit is provided. The valve is then at least partially opened and images are captured in-situ of the at least partially opened valve with the valve being exposed to the fluid.

### FIELD OF THE INVENTION

The present invention relates to visual inspection techniques, and more particularly to a method and system for in-situ visual inspection of a valve.

### BACKGROUND OF THE INVENTION

Ship side valves are typically fitted in the bottom portion of a ship's hull connecting the ships ballast tanks to the open sea to enable inflow and outflow of water ballast. Placement of the ship side valve in the bottom portion of a ship's hull exposes the valve to a pressure that is proportional to the distance between the valve and the water surface and is known as the Head Pressure. Proper operation of the ship side valves is essential for the safety of the ship or other vessels such as, for example, drill rigs (hereinafter, the word “ship” will be understood to include vessels such as offshore drilling, and oil and gas rigs). Therefore, the ship side valves are required to be visually inspected in regular time intervals—typically every 5 years.

Present day technology requires removal of the ship side valves for inspection. Unfortunately, placement of the ship side valves in the bottom portion of a ship's hull—i.e. well below the water line—makes such and inspection process difficult and costly. Typically, a ship is placed in a dry dock in order to be able to remove the ship side valve making the inspection equipment and labour intensive and, therefore, very expensive. Alternatively, divers or Remotely Operated Vehicles (ROVs) are employed—for example, for inspecting ship side valves of vessels such as drill rigs—to externally plug the water intake connected to the ship side valve so the valve can be removed for inspection. However, the external plugging of the water intake using divers or ROVs is labour intensive and expensive. Furthermore, this process has an added safety risk of a possible failure of the plug while the ship side valve is removed for inspection.

It is desirable to provide a method and system for in-situ visual inspection of a valve.

It is also desirable to provide a method and system for in-situ visual inspection of a valve that is simple to install and operate.

It is also desirable to provide a method and system for in-situ visual inspection of a valve that is safe to install and operate.

### SUMMARY OF THE INVENTION

Accordingly, one object of the present invention is to provide a method and system for in-situ visual inspection of a valve.

Another object of the present invention is to provide a method and system for in-situ visual inspection of a valve that is simple to install and operate.

Another object of the present invention is to provide a method and system for in-situ visual inspection of a valve that is safe to install and operate.

According to one aspect of the present invention, there is provided a method for visually inspecting a valve. The valve controls of a fluid from a first fluid conduit to a second fluid conduit. A tethered imaging device is disposed in the second fluid conduit. The tether extends from inside the second fluid conduit to outside the second fluid conduit. An image capturing end portion of the imaging device is moved in proximity to the valve. A fluid seal for fluid sealing a passage of the tether from inside the second fluid conduit to outside the second fluid conduit is provided. The valve is then at least partially opened and images are captured in-situ of the at least partially opened valve with the valve being exposed to the fluid.

According to the aspect of the present invention, there is provided a system for visually inspecting a valve. The valve controls of a fluid from a first fluid conduit to a second fluid conduit. The system comprises a tethered imaging device for being disposed in the second fluid conduit such that the tether extends from inside the second fluid conduit to outside the second fluid conduit and is of sufficient length for placing an image capturing end portion of the imaging device at least in proximity to the valve. The imaging device is for capturing images of the valve in-situ with the valve being at least partially opened and exposed to the fluid. The system further comprises a fluid seal for fluid sealing a passage of the tether from inside the second fluid conduit to outside the second fluid conduit. The fluid seal enables movement of the tether there through in a first mode of operation and fluid seals the passage of the tether in a second mode of operation.

The advantage of the present invention is that it provides a method and system for in-situ visual inspection of a valve.

A further advantage of the present invention is that it provides a method and system for in-situ visual inspection of a valve that is simple to install and operate.

A further advantage of the present invention is that it provides a method and system for in-situ visual inspection of a valve that is safe to install and operate.

### BRIEF DESCRIPTION OF THE DRAWINGS

A preferred embodiment of the present invention is described below with reference to the accompanying drawings, in which:

FIGS. 1a to 1e are simplified block diagrams illustrating a system for in-situ visual inspection of a valve according to a preferred embodiment of the invention;

FIGS. 2a to 2c are simplified block diagrams illustrating further embodiments of the system for in-situ visual inspection of a valve; and,

FIG. 3 is a simplified flow diagram illustrating a method for in-situ visual inspection of a valve according to a preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments herein below is with reference to in-situ visual inspection of a ship side valve, it will become evident to those skilled in the art that the embodiments of the invention are not limited thereto, but are also applicable for in-situ visual inspection of valves employed in various other applications such as, for example, pipelines, where removal of the same for inspection is difficult and/or poses a safety risk.

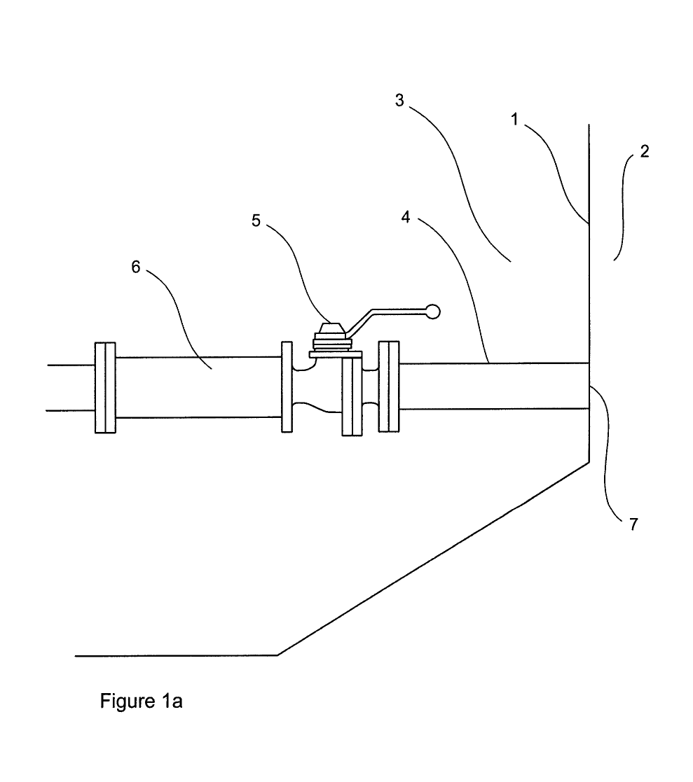

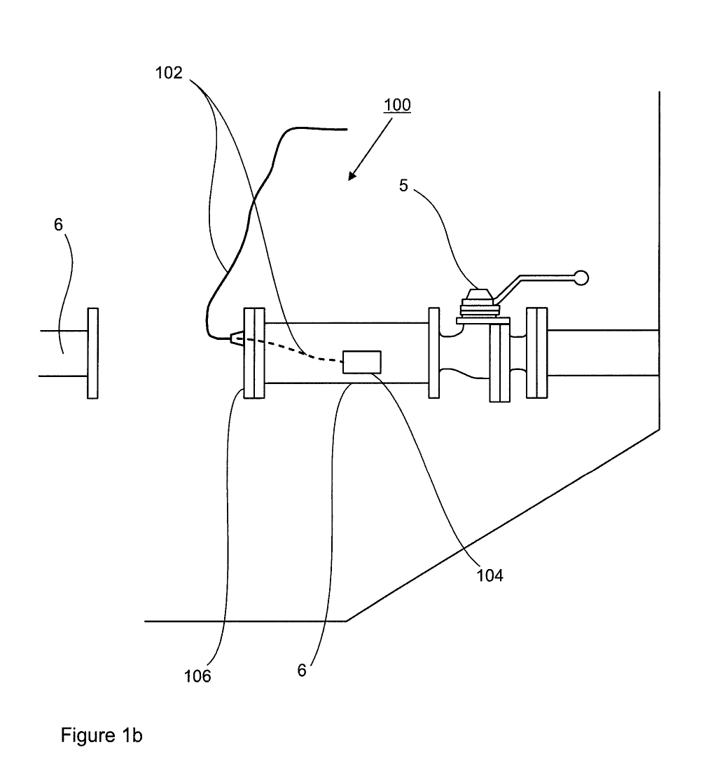

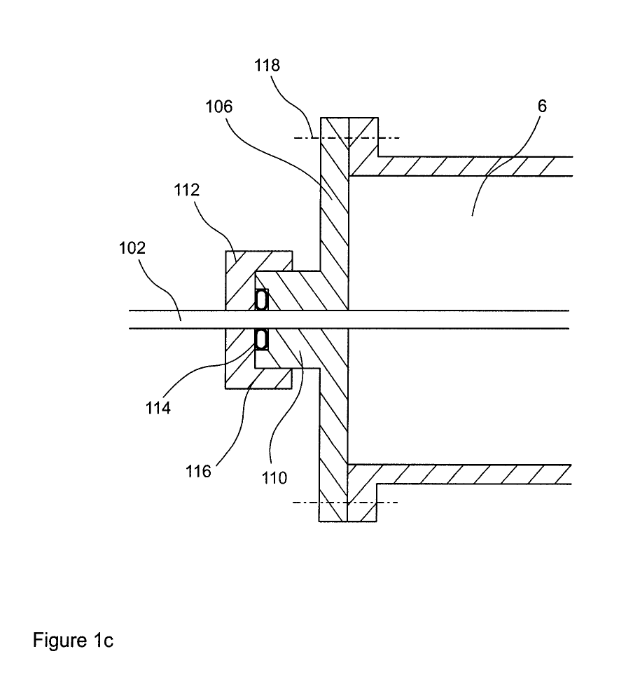

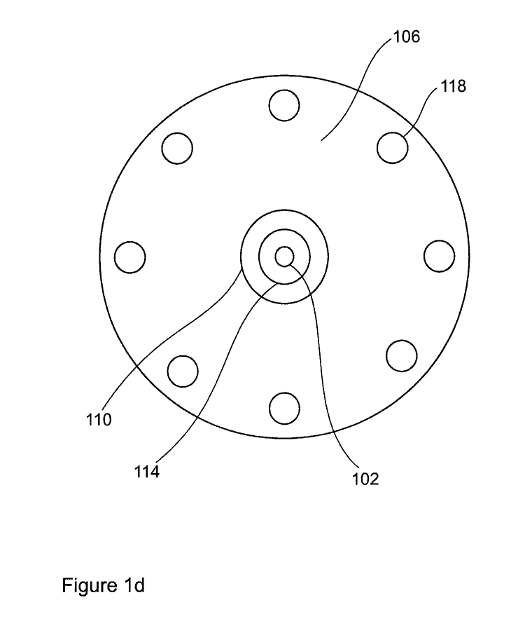

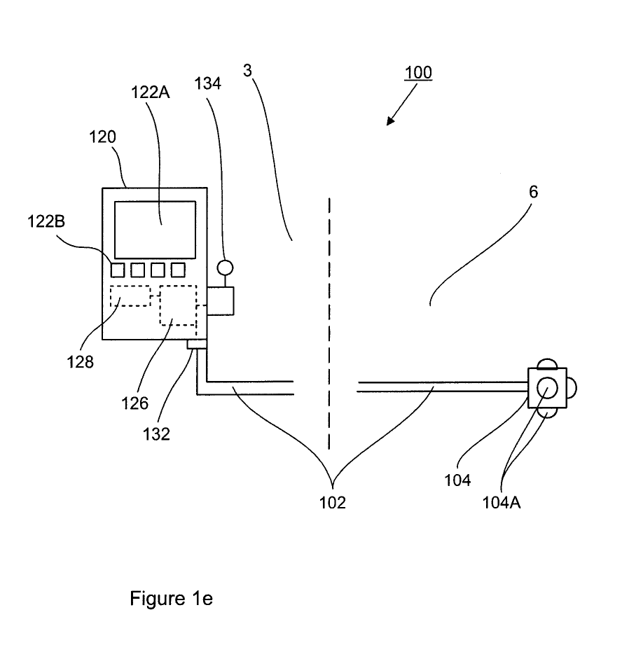

Referring to FIGS. 1a to 1e, a system 100 for in-situ visual inspection of a valve according to a preferred embodiment of the invention is provided. As illustrated in FIG. 1a, the ship side valve 5 is placed inside 3 the bottom portion of the ship's hull 1 disposed between a first fluid conduit 4 and second fluid conduit 6. The first fluid conduit receives water 2 via inlet 7, while the second fluid conduit 6 provides the water to a ballast tank (not shown) when the ship side valve 5 is opened. Figure lb illustrates the system 100 installed in the second fluid conduit 6 with a portion of the same replaced for providing access. The system 100 comprises a tether 102 that extends from inside the second fluid conduit 6 to outside the second fluid conduit. The tether 102 is of sufficient length for placing an image capturing end portion 104 of an imaging device in proximity to the valve 5 for enabling image capturing of the valve 5 in-situ. Sealing flange 106 is mounted to the fluid conduit 6 in a known fluid sealing fashion using, for example, screw bolts disposed in respective bores 118, illustrated in FIGS. 1c and 1d, and screw nuts. The sealing flange 106 comprises a passage for accommodating the tether therein and a fluid seal 114 for fluid sealing a passage of the tether from inside the second fluid conduit 6 to outside the second fluid conduit 6. Preferably, the fluid seal enables movement of the tether therethrough in a first mode of operation and fluid seals the passage of the tether in a second mode of operation, which is accomplished, for example, by providing an O-ring compression seal. For example, the flange 106 comprises adaptor 110 and compression nut 116 having disposed there between O-ring 114 with the O-ring 114 fitting around the tether 102 such that the tether 102 is movable and a fluid seal is provided when tightening compression nut 112 via screw mechanism 116. The O-ring 114 is an off-the shelf O-ring made of, for example, rubber. The compression nut 112 comprises, for example, a ½″ or ¾″ male NPT/standard thread 116 that interacts with a respective female thread 116 of the adaptor 110. Optionally, the flange 106 is omitted and the compression nut 112 with the O-ring 114 is directly mounted to a respective female thread disposed on the second fluid conduit 6. The compression nut 112 and the sealing flange 106 are made of a suitable material to withstand the pressure—typically in the range of 20 to 50 psi—and is, preferably, corrosion resistant such as, for example, stainless steel.

Various imaging devices for use with the system 100 are readily available such as, for example, fiberscopes, boroscopes, flexible probes, push rod cameras, well inspection cameras, video scopes, micro ROVs, or robotic crawler cameras.

Preferably, the tether 102 is connected to a computer 120, as illustrated in FIG. 1e. The computer comprises user interface 122 connected to processor 126 for displaying images 122A or videos captured by one or more cameras 104A placed in the image capturing end portion 104, and keyboard and for receiving user commands 122B. For example, the user interface 126 is provided using a touch screen or a combination of a display and push buttons. The computer is operated using the processor 126, for example, an off-the-shelf computer processor, for executing executable commands preferably stored in non-volatile memory 124 such as, for example, a hard-drive or flash memory. Preferably, the processor 122 is removably connected to the tether 102 via port 132 to facilitate installation. The computer 120 is used to: control the image/video capture; storing images in the memory 124; control operation of the camera(s) such as, for example, pan, tilt, and zoom; control operation of an ROV or crawler; and generating a valve inspection report in dependence upon a report template, the at least a portion of the captured images, and operator input data.

Optionally, operation of the camera(s) and the ROVs is facilitated by providing a joystick 134 connected to the processor 126.

Preferably, the computer 120 is provided in a rugged and substantially waterproof housing.

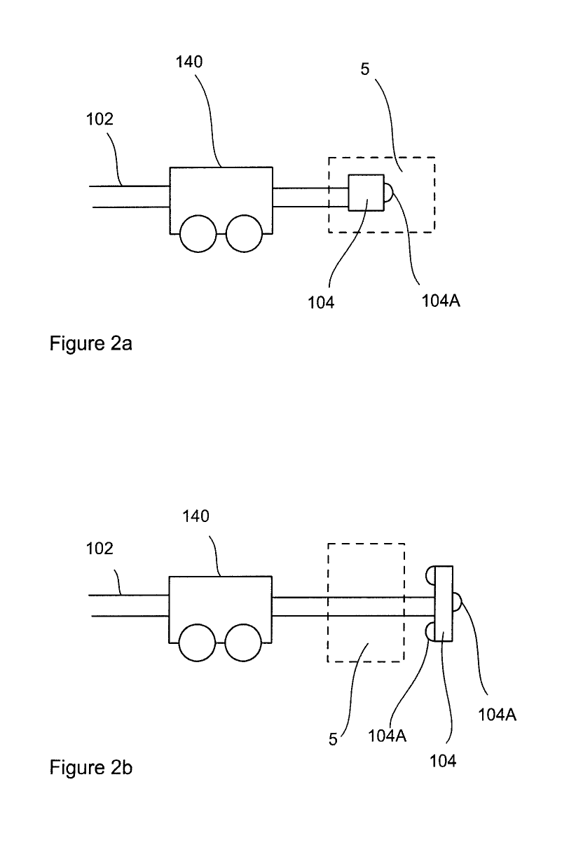

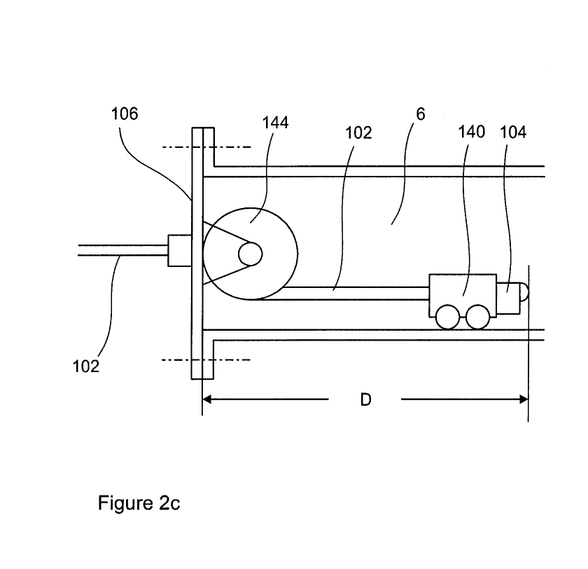

Optionally, the image capturing end portion 104 and the cameras 104A are placed forward of an ROV or Crawler 140, as illustrated in FIGS. 2a and 2b, to enable inspection inside the opened valve 5 or an opposite site of the valve 5 with at least an camera facing back as illustrated in FIG. 2b.

Further optionally, a spool 144 mounted to the flange 106 is provided having wound thereon the tether 102, as illustrated in FIG. 2c. When the ROV moves forward the tether is released from the spool 144 and when the ROV moves back the tether 102 is wound onto the spool, for example, by turning the spool using a spring mechanism. Release of the tether from the spool 144 enables measurement of a distance D traveled by the ROV 140. For example, when the measured distance D is indicative that the camera is placed inside or through the opened valve a warning message is provided to the operator to prevent closing of the valve while the camera is still inside.

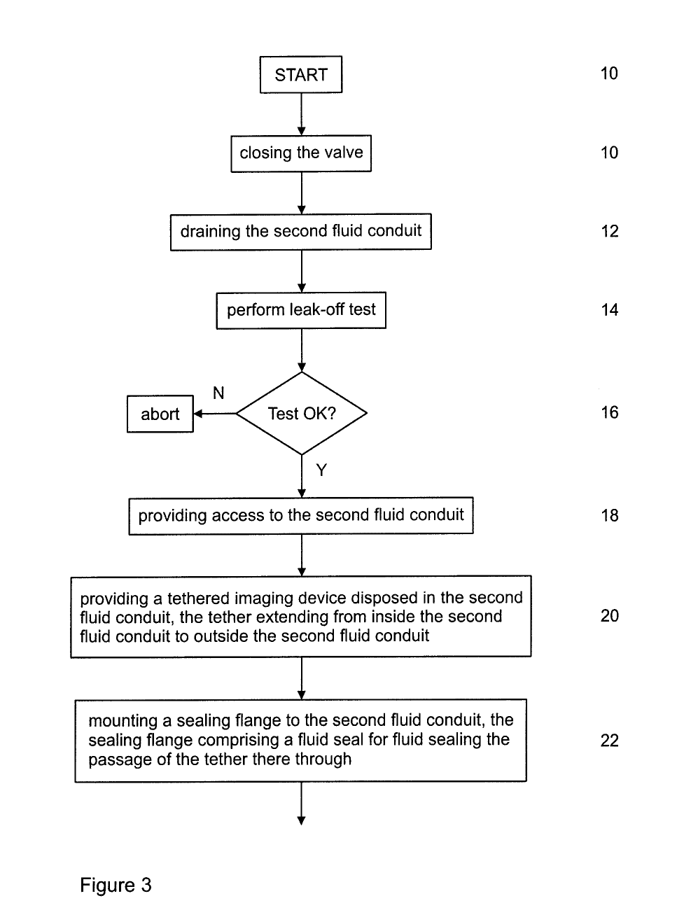

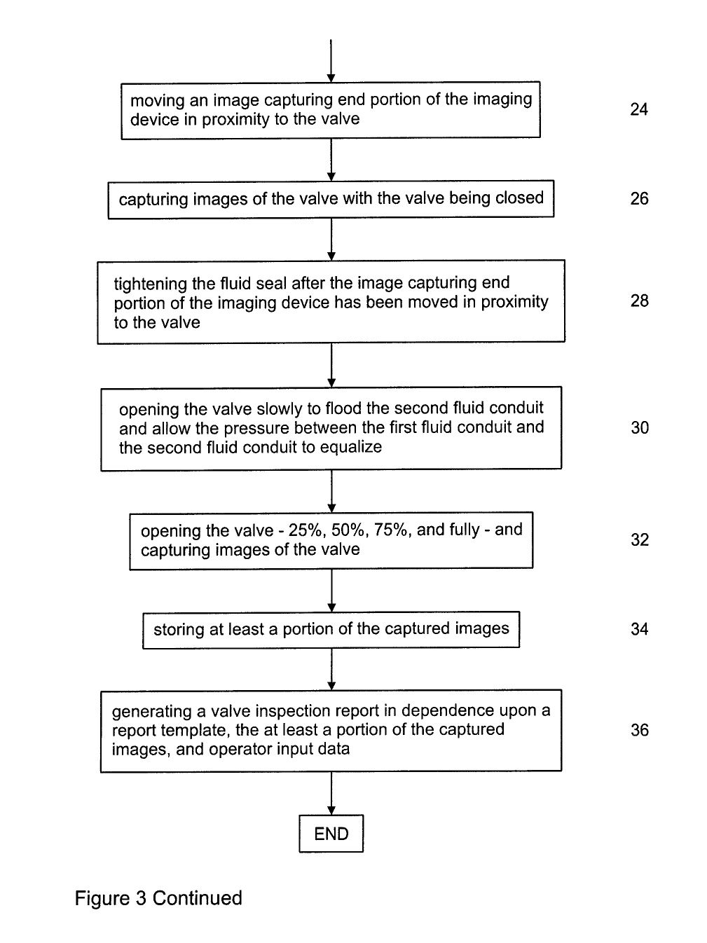

Referring to FIG. 3, a method for in-situ visual inspection of a valve according to a preferred embodiment of the invention is provided. At 10, the valve 5 is closed and the second fluid conduit is drained—12. At 14 a leak-off test is performed—typically, waiting 15 minutes to see if there is a leak—to ensure that the valve 5 is properly closed. If the leak test is indicative of a leak 16 the visual inspection process is aborted, otherwise the second fluid conduit 6 is opened to provide access thereto—18. The tethered imaging device 102, 104 is then disposed—20—in the second fluid conduit 6 with the tether 102 extending from inside the second fluid conduit 6 to outside the second fluid conduit 6 and the sealing flange 106 is mounted—22—to the second fluid conduit 6, as illustrated herein above. The image capturing end portion 104 of the imaging device is then moved—24—in proximity to the valve 5 and images of the closed valve 5 are captured—26—to perform an inspection of the valve seat identifying any leaks and to inspect the valve for damage, deformed seal/seat, fractures, and cracking. Defects are documented and video or still images thereof are captured and stored. Optionally, if a leak exists it is resealed or cleaned using a tethered mechanical cleaning tool such as for example, a rotating brush fitted through the sealing flange 106. If no leaks are identified a confirmation is made that the valve is able to hold its head pressure.

The fluid seal is then tightened—28—after the image capturing end portion 104 of the imaging device has been moved in proximity to the valve. Preferably, the compression nut 112 is tightened hand tight. The valve 5 is then slowly opened—30—to flood the second fluid conduit 6 and allow the pressure between the first fluid conduit 4 and the second fluid conduit 6 to equalize. The valve 5 is then opened—32—stepwise to 25%, 50%, 75%, and fully and images are captured. The valve operation is then inspected by opening and closing it several times. During this process seat, seal, disk stem and internal housing are inspected and any defects are noted. Captured images and/or video sequences are stored—34—and a valve inspection report is generated—36—in dependence upon a report template, the at least a portion of the captured images, and operator input data.

Once the inspection is completed the valve 5 is closed and the second fluid conduit 6 is drained. After it is confirmed that the valve is holding the head pressure the sealing flange 106 and the tethered imaging device 102, 104 is removed. Finally, the original components of the second fluid conduit are reinstalled.

To avoid damage to the camera the distance from the sealing flange to the valve 5 is measured to ensure that it is not too close to the valve when closing the same.

The method and system for in-situ visual inspection of a valve are applicable for the inspection of various typed of valves such as, for example, ball valves, globe valves, angle valves, butterfly valves, gate valves, diaphragm valves as well as three way and four way valves.

The present invention has been described herein with regard to preferred embodiments. However, it will be obvious to persons skilled in the art that a number of variations and modifications can be made without departing from the scope of the invention as described herein.

1. A method for visually inspecting a valve, the valve for controlling passage of a fluid from a first fluid conduit to a second fluid conduit, the method comprising:
providing a tethered imaging device disposed in the second fluid conduit, the tether extending from inside the second fluid conduit to outside the second fluid conduit;
moving an image capturing end portion of the imaging device in proximity to the valve;
providing a fluid seal for fluid sealing a passage of the tether from inside the second fluid conduit to outside the second fluid conduit;
at least partially opening the valve; and,
capturing images in-situ of the at least partially opened valve with the valve being exposed to the fluid.

2. A method as defined in claim 1 comprising tightening of the fluid seal after the image capturing end portion of the imaging device has been moved in proximity to the valve.

3. A method as defined in claim 1 comprising:
closing the valve; and,
draining the second fluid conduit.

4. A method as defined in claim 3 comprising:
opening the second fluid conduit; and,
mounting a sealing flange to the second fluid conduit, the sealing flange comprising the fluid seal for fluid sealing the passage of the tether there through.

5. A method as defined in claim 1 comprising moving the image capturing end portion of the imaging device inside the at least partially opened valve.

6. A method as defined in claim 5 comprising capturing images inside the at least partially opened valve.

7. A method as defined in claim 6 comprising providing an indication that the image capturing end portion of the imaging device is disposed inside the at least partially opened valve.

8. A method as defined in claim 7 comprising determining a distance travelled by the image capturing end portion of the imaging device.

9. A method as defined in claim 1 comprising storing at least a portion of the captured images.

10. A method as defined in claim 9 comprising providing a computer connected to the imaging device.

11. A method as defined in claim 10 comprising using a processor of the computer generating a valve inspection report in dependence upon a report template, the at least a portion of the captured images, and operator input data.

12. A system for visually inspecting a valve, the valve for controlling passage of a fluid from a first fluid conduit to a second fluid conduit, the system comprising:
a tethered imaging device for being disposed in the second fluid conduit such that the tether extends from inside the second fluid conduit to outside the second fluid conduit and is of sufficient length for placing an image capturing end portion of the imaging device at least in proximity to the valve, the imaging device for capturing images of the valve in-situ with the valve being at least partially opened and exposed to the fluid; and,
a fluid seal for fluid sealing a passage of the tether from inside the second fluid conduit to outside the second fluid conduit, the fluid seal for enabling movement of the tether there through in a first mode of operation and for fluid sealing the passage of the tether in a second mode of operation.

13. A system as defined in claim 12 wherein the fluid seal comprises an O-ring compression seal.

14. A system as defined in claim 13 comprising a sealing flange for being mounted to the second fluid conduit, the sealing flange comprising the fluid seal for fluid sealing the passage of the tether there through.

15. A system as defined in claim 12 wherein the image capturing end portion of the imaging device is disposed in a remotely operated vehicle connected to the tether.

16. A system as defined in claim 12 comprising a computer connected to the imaging device, the computer for storing at least a portion of the captured images and for generating a valve inspection report in dependence upon a report template, the at least a portion of the captured to images, and operator input data.
